(19) United States
(12) Patent Application Publication
(10) Pub. No.: US 2007/0221655 A1
(43) Pub. Date: Sep. 27, 2007

(54) DIGITAL MULTI-ZONE THERMOMETER

(76) Inventors: Jon Bridgwater, Glendora, CA (US); Martin Yan, Hacienda Heights, CA (US)

Correspondence Address: MACPHERSON KWOK CHEN & HEID LLP, 2033 GATEWAY PLACE, SUITE 400, SAN JOSE, CA, 95110, US

(21) Appl. No.: 11/683,958

(22) Filed: Mar. 8, 2007

Related U.S. Application Data
(60) Provisional application No. 60/780,102, filed on Mar. 8, 2006.

(51) Int. Cl. H05B 1/02

(52) U.S. Cl. 219/494

(57) ABSTRACT

A multi-zone temperature sensor system includes a plurality of temperature sensors associated with multiple zones in an appliance, such as a gas barbeque. A display and control panel is coupled to the sensors to display temperatures in each zone and controls to set desired temperatures in each zone. A timer and/or speaker may also be included. In one embodiment, a remote control with displays and control buttons can be used in conjunction with the system. By positioning the sensors at a location where the temperature parallels the grilling surface temperatures the user has a much better indication of when the grill is ready for use.

### CROSS REFERENCE TO RELATED APPLICATION

This application claims the benefit of U.S. Provisional Application No. 60/780,102, filed Mar. 8, 2006.

### BACKGROUND

1. Field of Invention

The present invention relates generally to temperature measurement devices, and more particularly to thermometers capable of displaying temperatures in multiple grilling zones at the grilling surface of a cooking appliance.

2. Related Art

Traditionally, most outdoor grills only have one temperature zone within the cooking area, similar to an oven. For example, a barbeque may only have one knob to control one or more burners so that the same amount of heat is generated from each burner(s) throughout the barbeque. Currently, most larger sized barbeques have multiple burners with multiple burner controls for heating the barbeque and barbeque grill. Individually controlled multiple burners enable specific zones of the barbeque to be heated, which provides more flexibility for the user. Multiple zones allow different foods requiring different temperatures to be cooked simultaneously in the barbeque since one zone can be heated to a higher temperature than another zone. For example, meats requiring high and/or direct heat can be cooked in one portion of the barbeque, while vegetables requiring low and/or indirect heat can be cooked in another portion.

Most outdoor cooking appliances, such as barbeques, have a temperature indicator, typically mounted on the front hood of a barbeque. The temperature indicator, which can be an analog or digital thermometer, enables the user to see when the barbeque reaches a desired internal temperature. However, typically only one temperature indicator is present, leaving the user to guess as to what the temperature is in each zone if the burners are operated at different levels. Conventional temperature indicators are also passive so that the user has to either continuously monitor the temperature or periodically check whether a desired temperature has been reached. This can be time-consuming, inconvenient, or problematic if the user forgets to check the temperature and the barbeque has been heated too high.

Therefore, there is a need for temperature monitoring system for outdoor appliances and grills that overcomes the disadvantages of conventional systems discussed above.

### SUMMARY

According to one aspect of the invention, a temperature monitoring system includes multiple temperature sensors within a cooking appliance, such as an outdoor gas barbeque grill, to monitor temperatures within specific zones of the appliance. A digital display shows the temperature at each zone. Thus, a user can accurately see the temperature at different locations in the appliance.

According to one embodiment, the temperature monitoring system enables the user to set a specific temperature for each zone or a specific time for heating each zone. Once a pre-set temperature or heating time is reached, an audible notification, such as an alarm, is sounded to notify the user. This eliminates the need for the user to continually or even periodically go to the barbeque to check the temperature.

According to another embodiment, a portable remote device is in communication with the temperature monitoring system in the barbeque so the user does not have to be close to the barbeque to hear the audio notification. The remote device may also have a display to allow the user to see the temperature within a zone and/or set a heat time.

### BRIEF DESCRIPTION OF THE DRAWING

FIG. 1 is a block diagram of a temperature monitoring system according to one embodiment;

FIG. 2 is a front view of the face of a display for the temperature monitoring system of FIG. 1;

FIGS. 3A and 3B show the placement of the display of FIG. 2 and temperature sensors on and within a gas barbeque grill, respectively, according to one embodiment; and

FIGS. 4A and 4B are side and front views of a remote device according to one embodiment for the temperature monitoring system of FIG. 1.

Embodiments of the present invention and their advantages are best understood by referring to the detailed description that follows.

### DETAILED DESCRIPTION

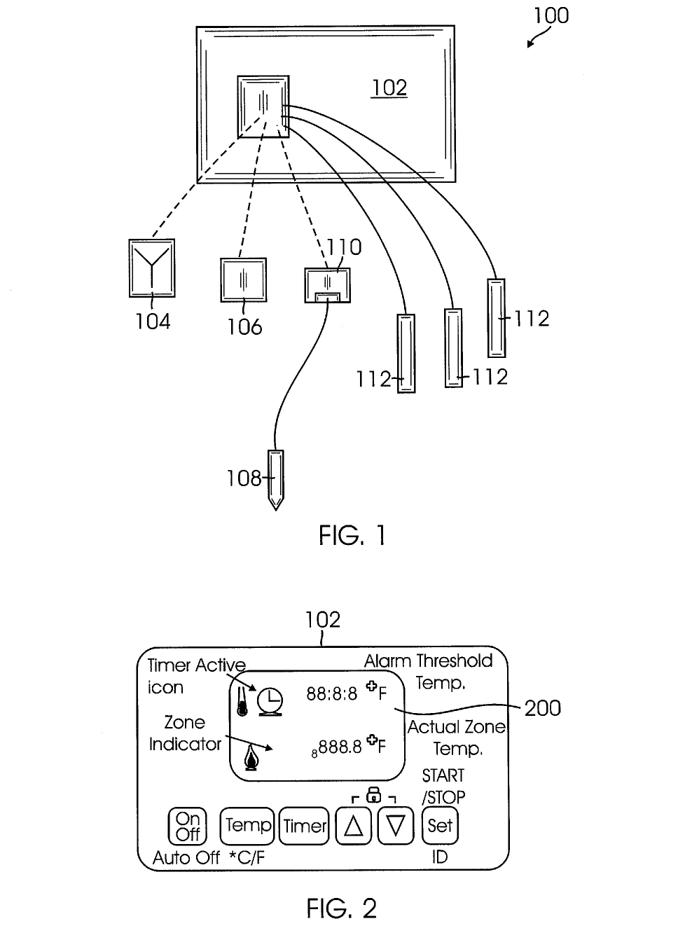

FIG. 1 shows a temperature monitoring system 100 according one embodiment of the present invention. Temperature monitoring system can be used in a cooking appliance which has multiple heating zones, such as a gas outdoor barbeque grill with multiple burners and burner controls. Temperature monitoring system 100 includes a control box 102 with an antenna 104, a battery holder 106, a meat probe 108 having a plug-in module 110, and multiple temperature sensors 112, such as “k” type thermocouples or thermisters. Note that any suitable temperature sensor may be used. Plug-in module 110 and temperature sensors 112 are connected to control box 102 with insulated wire pairs. Plug-in module 110 is located on control box 102 and allows meat probe 108 to be easily attached and detached from control box 102. FIG. 1 shows three sensors 112, however any number may be used, depending on how many zones or portions of the appliance are to be monitored at one time.

Antenna 104 can be any suitable antenna enabling communication with a remote device. Antenna 104 is located in control box 102 in one embodiment. Battery holder 106, which is optional, holds a battery, such as a 3V battery, to supply power to temperature monitoring system 100. Power can also be supplied using 110 AC volts with a step-down transformer power supply (not shown). Meat probe 108, such as a thermister or other conventional meat probe enables the user to measure the internal temperature of meat being cooked in the appliance.

Multiple temperature sensors 112 are used to measure temperature in specific zones or portions of the appliance. Three sensors are shown in FIG. 1, which would enable individual temperature measurement in three different zones. Each temperature sensor 112 is placed within a specific zone or area, where temperature information from each sensor 112 is communicated to control box 102 for display to the user.

FIG. 2 is a front view of control box 102 according to one embodiment. Control box 102 includes a digital display 200, such as an LCD screen. Information available on the screen may include the desired temperature in a zone, the current temperature in a zone, the zone number, and a timer active indicator. Other information may include the time remaining in a zone. Control box 102 also includes controls for operating the temperature control system. In this embodiment, the controls include an on/off button, a temperature button, a timer button, up and down scroll buttons, and a set button. Other control buttons, as desired, may be added, deleted, or otherwise substituted.

In operation, the temperature monitoring system can be turned off and on by pushing the on/off button. If the system is off, pushing the on/off button turns the system on, and if the system is on, pushing the on/off button turns the system off. Once on, the display shows the temperature in each zone in sequence. For example, the temperature in zone one will first be displayed, with a number one along-side the temperature to indicate that it is in zone one. After a pre-determined time, such as 2 seconds, although any suitable time may be used, the display shows the temperature in zone two with a number two shown as well. This cycling of temperatures in each zone continues until the user interrupts it or the system is shut down.

For monitoring a temperature in a specific zone, the user waits until the desired zone is displayed, at which time, the user presses the temperature button to stop the zone cycling. The temperature at that zone will now be continually displayed. To continue zone temperature scanning and display, the user presses the temperature button again. The display also has the ability to display temperature in Fahrenheit or Celsius. To switch between units, the user simply presses and holds the temperature button for a certain period of time, such as 3 seconds, until the display only shows either an F or a C (for Fahrenheit or Celsius, respectively). The user can then press the up or down button to change the display to a desired temperature scale.

To set a temperature in a specific zone, the user first selects the desired zone, as discussed above. The set button is then pushed and released, which causes a first digit of the set or threshold temperature on the display to start blinking. The user then presses the up or down button to change the number for the first blinking digit. When the desired number is reached, the set button is pushed again, which sets the first digit and starts a second digit of the threshold temperature blinking. The up/down buttons are pressed until the desired number is displayed, and the set button is pushed to set that number. This process continues until the desired temperature is set. Any suitable method for setting the temperature can be used, such as using the up or down buttons to count up or down, similar to settings for a clock. In other words, to increase a temperature setting from 100 degrees to 400 degrees, the user simply presses and holds the up button, which will cause the numbers to increase. If the button is held for a predetermined amount of time, the increase speeds up.

Pressing the temperature button resumes the temperature scanning. When the desired temperature is reached or exceeded in the selected zone, an alarm sounds to notify the user.

Once the thermometer or temperature has been set, the timer can be set to notify the user when a set time has elapsed. First, the timer button is pressed and released, which causes the minutes display to start blinking. The up and/or down buttons are pressed until a desired minute setting is shown. The timer button is then pressed, which sets the minute setting and causes the hours display to start blinking. The up/down arrows are pressed until the desired hours setting is reached. The set button is then pressed to set the timer and start the count down. To go back to the temperature screen, the temperature button is pressed to display the current temperature in the zone. Once the timer reaches zero, an audio notification occurs.

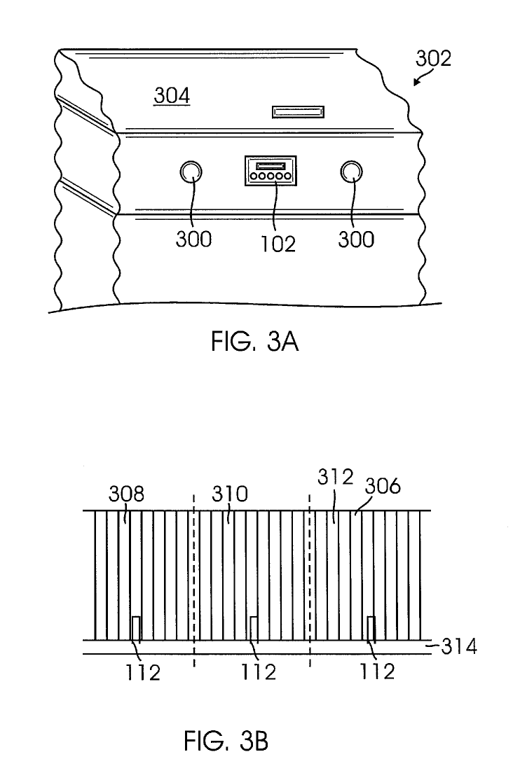

FIGS. 3A and 3B show the positioning of control box 102 and temperature sensors 112 according to one embodiment. In FIG. 3A, control box 102 is positioned along the same panel as burner control knobs 300 of an appliance 302, e.g., a front-facing side. In this example, control box 102 is positioned between two knobs 300, approximately centered horizontally on the appliance or barbeque grill 302. This enables easy user viewing, although other positions may also be suitable, such as at one end or the other of the barbeque grill. Location on the same panel as the control knobs, as opposed to on the hood or lid 304 of the grill, keeps the display in a stationary position for ease of use and viewing. In FIG. 3B, a top view of a grill 306 is shown having three zones or portions 308, 310, and 312, each controlled on one or more burners thereunder (not shown). Temperature sensors 112 are mounted to a portion 314 of the housing of the appliance, with the tip of the sensor in proximity to the burner and below the cooking surface of the grill. Each sensor is calibrated, based on position, to transmit an accurate temperature for its associated grilling surface or zone. Note that a zone can be a surface, area, or volume.

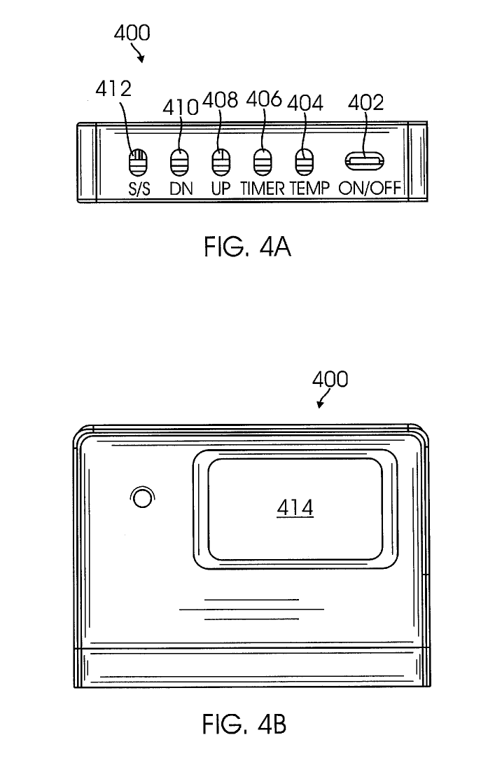

FIGS. 4A and 4B are side and front views of a remote control device 400 suitable for use with the present invention. Device 400 can be a wireless remote monitor capable of wireless communication from control box 102 via the antenna. On the side of device 400 are a row of buttons, which perform the same functions as the buttons on control box 102. In particular, the side of device 400 includes an on/off switch 402, a temperature switch 404, a timer switch 406, an up switch 48, a down switch 410, and a set or start/stop switch 412. Referring to FIG. 4B, device 400 has a front face with a display 414, such as an LCD display. Display 414 displays the same information as the display for control box 102, i.e., desired temperature, current temperature, zone indicator, and timer active indicator. Device 400 is also equipped with a speaker to notify the user when a desired temperature or elapsed time has been reached.

Having thus described embodiments of the present invention, persons skilled in the art will recognize that changes may be made in form and detail without departing from the scope of the invention.

We claim:

1. A temperature monitoring system for use with an outdoor cooking appliance, comprising:
a plurality of temperature sensors located apart from each other, wherein each temperature sensor is associated with one grilling surface or zone of the cooking appliance; and
a control and display panel coupled to the temperature sensors, wherein the panel comprises a temperature control for setting desired temperatures at each grilling surface or zone.

2. The system of claim 1, wherein the coupling is wired.

3. The system of claim 1, further comprising a remote monitoring device in wireless communication with the panel.

4. The system of claim 3, wherein the remote monitoring device comprises a temperature control for setting the desired temperatures and a visual display showing temperatures in each zone.

5. The system of claim 1, wherein the panel further comprises a timer control.

6. The system of claim 1, wherein the panel further comprises a display capable of displaying the temperature in each zone.

7. The system of claim 6, wherein the displaying is sequential.

8. The system of claim 1, further comprising a detachable meat probe and/or a power source.

9. The system of claim 8, wherein the power source is a battery or an electrical adapter.

10. The system of claim 1, wherein the appliance is a barbeque.

11. The system of claim 1, wherein the display is digital.

12. The system of claim 1, wherein the display comprises a speaker for audio notification.

13. A cooking appliance having a multi-zone temperature monitoring system, comprising:
a lid for the appliance;
an enclosure fitted underneath the lid;
a plurality of heating elements within the enclosure, wherein the heating elements define different heating zones;
a temperature sensor disposed within each heating zone; and
a control and display panel disposed on an outer portion of the appliance coupled to the temperature sensors, wherein the panel comprises a temperature control for setting desired temperatures in each zone and a display for showing the temperature in each zone.

14. The appliance of claim 13, wherein the panel is disposed on the enclosure.

15. The appliance of claim 13, wherein the appliance is a barbeque.

16. The appliance of claim 13, wherein the coupling is wired.

17. The appliance of claim 13, further comprising a remote control device in wireless communication with the panel.

18. The appliance of claim 17, wherein the remote control comprises a temperature control for setting the desired temperatures and a visual display showing temperatures in each zone.

19. The appliance of claim 13, wherein the panel further comprises a timer control.

20. The appliance of claim 13, wherein the panel further comprises a display capable of displaying the temperature in each zone.

21. The appliance of claim 20, wherein the displaying is sequential.

22. The appliance of claim 13, further comprising a detachable meat probe and/or a power source.

23. The system of claim 22, wherein the power source is a battery or an electrical adapter.

24. The appliance of claim 12, wherein the display is digital.

25. The appliance of claim 12, wherein the display comprises a speaker for audio notification.
